(19) United States
(12) Patent Application Publication
(10) Pub. No.: US 2024/0114966 A1
(43) Pub. Date: Apr. 11, 2024

(54) AEROSOL GENERATING SYSTEM AND METHOD FOR MANUFACTURING AEROSOL GENERATING SYSTEM

(71) Applicant: JAPAN TOBACCO INC., Tokyo (JP)

(72) Inventors: Takafumi IZUMIYA, Tokyo (JP); Kazutoshi SERITA, Tokyo (JP); Reijiro KAWASAKI, Tokyo (JP)

(73) Assignee: JAPAN TOBACCO INC., Tokyo (JP)

(21) Appl. No.: 18/540,184

(22) Filed: Dec. 14, 2023

Related U.S. Application Data
(63) Continuation of application No. PCT/JP2021/034234, filed on Sep. 17, 2021.

(51) Int. Cl. A24F 40/465; A24F 40/20

(52) U.S. Cl. CPC A24F 40/465; A24F 40/20; A24F 40/65

(57) ABSTRACT

An aerosol generating system including a holder unit that can house, in the interior space thereof, an aerosol source-containing substrate; and an electromagnetic induction source that generates a fluctuating magnetic field in the aforesaid interior space using an alternating current and heats the aerosol source by inductive heating due to the fluctuating magnetic field, wherein the electromagnetic induction source comprises a first layer, a conductor layer that is formed on one surface of the first layer and generates the fluctuating magnetic field, and a second layer that is formed on the aforesaid surface of the first layer so as to cover the conductor layer.

### CROSS-REFERENCES TO RELATED APPLICATIONS

This application is a continuation application based on International Patent Application No. PCT/JP2021/034234 filed on Sep. 17, 2021, and the content of the PCT international application is incorporated herein by reference.

### TECHNICAL FIELD

The present invention relates to an aerosol generating system and a manufacturing method for an aerosol generating system.

### BACKGROUND ART

An inhaler device, such as an electronic tobacco and a nebulizer, that generates material to be inhaled by a user is widely used. An inhaler device uses an aerosol source for generating an aerosol and a flavor source for imparting a flavor component to the generated aerosol, thus making it possible to generate an aerosol with the imparted flavor component. The user is able to taste a flavor by inhaling the aerosol with the imparted flavor component, generated by the inhaler device.

In recent years, an inhaler device that generates an aerosol from an aerosol source by inductively heating a susceptor or the like in thermal proximity to the aerosol source has become a focus of attention. For example, PTL 1 describes an inhaler device that uses a coil for induction heating. The coil is formed on a film by printing.

### CITATION LIST

### Patent Literature

Patent Literature 1: JP 2020-127433 A

### SUMMARY OF INVENTION

### Technical Problem

However, in the inhaler device described in PTL 1, the reliability of the coil formed on the film is not sufficiently considered. For example, there is a possibility that a crack or the like occurs in the coil resulting from repetition of thermal expansion and thermal contraction due to induction heating.

The present invention is contemplated in view of the above problem, and it is an object of the present invention to provide a new and improved aerosol generating system and a manufacturing method for an aerosol generating system, which are capable of further improving the reliability of an electromagnetic induction source including a coil.

### Solution to Problem

To solve the above problem, an aspect of the present invention provides an aerosol generating system. The aerosol generating system includes: a holder having an internal space in which a substrate containing an aerosol source is allowed to be accommodated; and an electromagnetic induction source that generates a varying magnetic field in the internal space by using an alternating current to heat the aerosol source by induction heating caused by the varying magnetic field. The electromagnetic induction source includes a first layer, a conductor layer that is provided on one side of the first layer and that generates the varying magnetic field, and a second layer provided on the one side of the first layer so as to cover the conductor layer.

The electromagnetic induction source may be provided around the holder.

The electromagnetic induction source may be wound around the holder in a cylindrical shape.

The electromagnetic induction source may be provided around the holder such that the first layer is opposed to the holder.

A Young's modulus of the second layer may be lower than a Young's modulus of the first layer.

A thickness of the second layer on the conductor layer may be greater than a thickness of the first layer.

An organic resin that is a component of the first layer may be the same as an organic resin that is a component of the second layer.

The substrate may be heated from inside by the induction heating, and a heat conductivity of the first layer may be higher than a heat conductivity of the second layer.

The first layer may contain an inorganic insulating filler.

A heat conductivity of the second layer may be higher than a heat conductivity of the first layer.

The second layer may contain an inorganic insulating filler.

The electromagnetic induction source may further include a thermal diffusion layer provided on an outer surface of the second layer and thermally connected to the second layer.

The electromagnetic induction source may be wound around the holder in a cylindrical shape such that the first layer is placed inside, the thermal diffusion layer may extend in an axial direction of the cylindrical shape beyond an end of the first layer, and a cooling portion is provided in an extended region of the thermal diffusion layer and cools the thermal diffusion layer.

The cooling portion may be provided in the extended region extending toward a side opposite to a side where an opening is provided in the axial direction of the cylindrical shape, and the opening may communicate with the internal space of the holder.

The cooling portion may be provided in the extended region on a surface opposed to the second layer.

The cooling portion may include a Pertier element.

The electromagnetic induction source may further include a magnetic field convergence layer provided between the second layer and the thermal diffusion layer and made of a magnetic substance.

The conductor layer may be a component of a coil of a transverse type or a solenoid type.

The aerosol generating system may further include the substrate accommodated in the internal space of the holder.

To solve the above problem, another aspect of the present invention provides a manufacturing method for an aerosol generating system. The manufacturing method includes: preparing a film first layer; forming a conductor layer on the first layer for generating a varying magnetic field caused by an alternating current; forming a second layer on the first layer such that the second layer covers the conductor layer; and providing a laminated body on a holder having an providing a laminated body on a holder having an internal space in which a substrate containing an aerosol source is allowed to be accommodated, the laminated body including the first layer, the conductor layer, and the second layer.

### Advantageous Effects of Invention

As described above, according to the present invention, it is possible to further improve the reliability of an electromagnetic induction source including a coil.

### BRIEF DESCRIPTION OF DRAWINGS

FIG. 1 is a schematic diagram that illustrates a configuration example of an inhaler device according to an embodiment of the present invention.

FIG. 2 is a schematic sectional view of a holder and an electromagnetic induction source.

FIG. 3 is an enlarged sectional view that illustrates a region near a conductor layer included in the electromagnetic induction source.

FIG. 4 is a schematic diagram that illustrates an example of the shape of a coil made up of a conductor layer.

FIG. 5 is a view that illustrates stress generated when the electromagnetic induction source is deformed.

FIG. 6 is an enlarged sectional view that illustrates a region near the conductor layer included in the electromagnetic induction source according to a first specific example.

FIG. 7 is an enlarged sectional view that illustrates a region near the conductor layer included in the electromagnetic induction source according to a second specific example.

FIG. 8 is an enlarged sectional view that illustrates a region near the conductor layer included in the electromagnetic induction source according to a third specific example.

FIG. 9 is an enlarged sectional view that illustrates a region near the conductor layer included in the electromagnetic induction source according to a fourth specific example.

FIG. 10 is an enlarged sectional view that illustrates a region near the conductor layer included in the electromagnetic induction source according to a fifth specific example.

FIG. 11 is an enlarged sectional view that illustrates a region near the conductor layer included in the electromagnetic induction source according to a sixth specific example.

FIG. 12A is a view that illustrates a process of manufacturing an electromagnetic induction source.

FIG. 12B is a view that illustrates the process of manufacturing the electromagnetic induction source.

FIG. 12C is a view that illustrates the process of manufacturing the electromagnetic induction source.

FIG. 12D is a view that illustrates the process of manufacturing the electromagnetic induction source.

### DESCRIPTION OF EMBODIMENTS

Hereinafter, a preferred embodiment of the present invention will be described in detail with reference to the attached drawings. In the specification and the drawings, like reference signs denote structural elements having substantially the same functional components, and the description will not be repeated.

### 1. Configuration of Inhaler Device

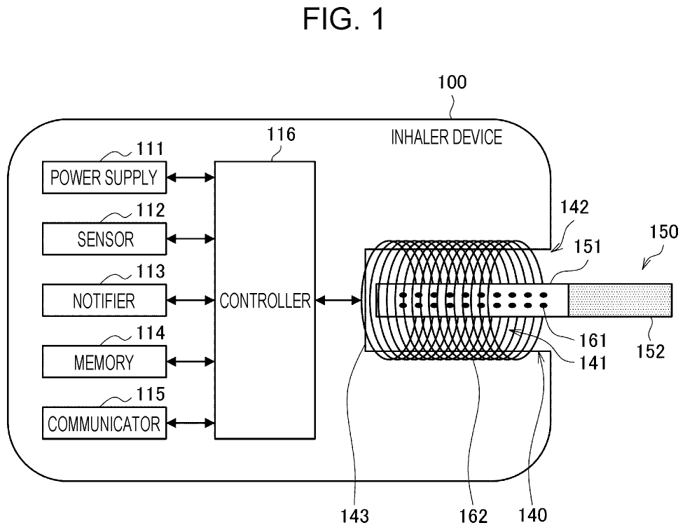

Initially, a configuration example of an inhaler device according to an embodiment of the present invention will be described with reference to FIG. 1. FIG. 1 is a schematic diagram that illustrates a configuration example of the inhaler device 100 according to the present embodiment.

As shown in FIG. 1, the inhaler device 100 includes, for example, a power supply 111, a sensor 112, a notifier 113, a memory 114, a communicator 115, a controller 116, a susceptor 161, an electromagnetic induction source 162, and a holder 140.

The inhaler device 100 according to the present embodiment heats a stick substrate 150 including an aerosol source by induction heating (IH) in a state where the stick substrate 150 is held by the holder 140. Thus, the aerosol source included in the stick substrate 150 is atomized, with the result that an aerosol is generated from the stick substrate 150. The generated aerosol is inhaled by a user.

The inhaler device 100 and the stick substrate 150 cooperate to generate an aerosol to be inhaled by the user. Therefore, a combination of the inhaler device 100 and the stick substrate 150 may be regarded as an aerosol generating system.

The power supply 111 stores electric power and supplies electric power to the structural elements of the inhaler device 100. The power supply 111 may be a rechargeable secondary battery, such as a lithium ion secondary battery. The power supply 111 may be charged when connected to an external power supply with a universal serial bus (USB) cable or the like. Alternatively, the power supply 111 may be charged by a power transmitting device not directly connected, with a wireless power transmission technology. Furthermore, the power supply 111 may be provided so as to be detachable from the inhaler device 100 or may be provided so as to be replaceable with a new power supply 111.

The sensor 112 detects various pieces of information on the inhaler device 100 and outputs the detected information to the controller 116. In an example, the sensor 112 may be a pressure sensor, such as a capacitor microphone, a flow sensor, or a temperature sensor. In such a case, when the sensor 112 detects a numeric value resulting from user's inhalation, the sensor 112 is allowed to output, to the controller 116, information indicating that the user has inhaled In another example, the sensor 112 may be an input device, such as a button and a switch, that receives input of information from the user or may be configured to include, for example, a button for instructing to start or stop to generate an aerosol. In such a case, the sensor 112 can output, to the controller 116, information input by the user. In another example, the sensor 112 may be a temperature sensor that detects the temperature of the susceptor 161. The temperature sensor may detect the temperature of the susceptor 161 in accordance with, for example, the electric resistance value of the electromagnetic induction source 162. In such a case, the sensor 112 can detect the temperature of the stick substrate 150 held by the holder 140 in accordance with the temperature of the susceptor 161.

The notifier 113 notifies the user of information. In an example, the notifier 113 may be a light-emitting device, such as a light emitting diode (LED). With this configuration, the notifier 113 can emit light in a different pattern of light, for example, when the state of the power supply 111 is a charging required state, when the power supply 111 is in being charged, or when there is an abnormality in the inhaler device 100. The pattern of light here is a concept including color, the timing to turn on or off, and the like. The notifier 113 may be a display device that displays an image, a sound output device that outputs sound, a vibration device that vibrates, or the like, in addition to or instead of the light-emitting device. Other than the above, the notifier 113 may notify information indicating that the user is allowed to inhale. The information indicating that the user is allowed to inhale is notified of the user when, for example, the temperature of the stick substrate 150 heated by electromagnetic induction reaches a predetermined temperature.

The memory 114 stores various pieces of information for the operation of the inhaler device 100. The memory 114 is, for example, a non-volatile storage medium, such as a flash memory. An example of the pieces of information stored in the memory 114 is information regarding an operating system (OS) of the inhaler device 100, such as the content of control over various structural elements by the controller 116. Another example of the pieces of information stored in the memory 114 is information regarding user's inhalation, such as the number of times of inhalation, inhalation time, and an accumulated inhalation time period.

The communicator 115 is a communication interface for transmitting and receiving information between the inhaler device 100 and another device. The communicator 115 is capable of performing communication that conforms with any wired or wireless communication standard. A wireless local area network (LAN), a wired LAN, Wi-Fi (registered trademark), Bluetooth (registered trademark), or the like can be adopted as such a communication standard. In an example, the communicator 115 may transmit information regarding user's inhalation to a smartphone in order to display the information regarding user's inhalation on the smartphone. In another example, the communicator 115 may receive new information on the OS from a server in order to update the information on the OS, stored in the memory 114.

The controller 116 functions as an arithmetic processing unit and a control device and controls the overall operations in the inhaler device 100 in accordance with various programs. The controller 116 may be implemented by, for example, an electronic circuit, such as a central processing unit (CPU) and a microprocessor. The controller 116 may be configured to further include a read only memory (ROM) that stores programs, arithmetic parameters, and the like, to be used, and a random access memory (RAM) that temporarily stores variable parameters as needed.

Specifically, the controller 116 may control execution of various pieces of processing related to operation of the inhaler device 100. For example, the controller 116 may control execution of pieces of processing, such as feeding of electric power from the power supply 111 to other structural elements, charging of the power supply 111, detection of information by the sensor 112, notification of information by the notifier 113, storing or reading of information by the memory 114, and transmitting and receiving of information by the communicator 115. In addition, the controller 116 is capable of controlling execution of processing or the like based on information input to structural elements and output from the structural elements, executed by the inhaler device 100.

The holder 140 has an internal space 141. The holder 140 holds the stick substrate 150 by accommodating part of the stick substrate 150 in the internal space 141. The holder 140 has an opening 142 that allows the internal space 141 to communicate with outside. The holder 140 holds the stick substrate 150 that is inserted into the internal space 141 through the opening 142. For example, the holder 140 may have a cylindrical shape such that the opening 142 and a bottom 143 are ends and the columnar internal space 141 is defined. The holder 140 can be formed such that the inside diameter is smaller than the outside diameter of the stick substrate 150 in at least part of the cylindrical body in the height direction. The holder 140 can hold the stick substrate 150 such that the stick substrate 150 inserted in the internal space 141 is pressed from the outer circumference.

The holder 140 also has the function to define a flow path for air passing through the stick substrate 150. An air inlet hole that is an inlet for air into the flow path is disposed at, for example, the bottom 143. On the other hand, an air outlet hole that is an outlet for air from the flow path is the opening 142.

The stick substrate 150 is a stick member. The stick substrate 150 includes a substrate 151 and an inhalation port 152.

The substrate 151 includes an aerosol source. When the aerosol source is heated, the aerosol source is atomized to generate an aerosol. The aerosol source may be, for example, a processed substance derived from tobacco and may be a processed substance obtained by forming shredded tobacco or tobacco raw material into a granular form, a sheet form, or a powder form. The aerosol source may contain a component not derived from tobacco and produced from a plant other than tobacco (for example, mint, a herb, or the like). In an example, the aerosol source may contain a flavoring agent component. When the inhaler device 100 is a medical inhaler, the aerosol source may contain a medicine for a patient to inhale. The aerosol source is not limited to a solid and may be, for example, a liquid, such as polyhydric alcohol and water. Examples of the polyhydric alcohol include glycerine and propylene glycol. At least part of the substrate 151 is accommodated in the internal space 141 of the holder 140 in a state where the stick substrate 150 is held by the holder 140.

The inhalation port 152 is a member to be held in a mouth of the user during inhalation. At least part of the inhalation port 152 protrudes from the opening 142 in a state where the stick substrate 150 is held by the holder 140. When the user inhales with the inhalation port 152 protruding from the opening 142 in his or her mouth, air flows into the holder 140 through the air inlet hole (not illustrated). Air flowing in passes through the internal space 141 of the holder 140 (that is, the substrate 151) and reaches the inside of the mouth of the user together with an aerosol that is generated from the substrate 151.

The stick substrate 150 includes the susceptor 161. The susceptor 161 is capable of producing heat by electromagnetic induction. The susceptor 161 may be made of a conductive material. In an example, the susceptor 161 may be pieces of metal.

Specifically, the susceptor 161 may be disposed in thermal proximity to the aerosol source. The state where the susceptor 161 is in thermal proximity to the aerosol source means that the susceptor 161 is disposed at a location where heat generated at the susceptor 161 can be transferred to the aerosol source. For example, the susceptor 161 may be included in the substrate 151 together with the aerosol source so as to be surrounded by the aerosol source. With such a configuration, the susceptor 161 is capable of efficiently heating the aerosol source with the generated heat.

The susceptor 161 may be provided so as to be untouchable from outside of the stick substrate 150. For example, the susceptor 161 does not need to be disposed around the outer circumference of the stick substrate 150 and may be disposed only in a central part of the stick substrate 150.

The electromagnetic induction source 162 causes the susceptor 161 to produce heat by electromagnetic induction. When the electromagnetic induction source 162 is supplied with alternating current from the power supply 111, a varying magnetic field can be generated at a location that overlaps the internal space 141 of the holder 140. When the electromagnetic induction source 162 generates a varying magnetic field in a state where the stick substrate 150 is accommodated in the holder 140, eddy current is generated in the susceptor 161, so Joule heat can be generated in the susceptor 161. Joule heat generated in the susceptor 161 heats the aerosol source included in the stick substrate 150 to make it possible to generate an aerosol. A specific configuration of the electromagnetic induction source 162 will be described later.

When, for example, the sensor 112 detects that predetermined user input is performed, the inhaler device 100 may inductively heat the aerosol source included in the stick substrate 150 by feeding electric power to the electromagnetic induction source 162 to generate an aerosol. When the temperature of the aerosol source reaches a predetermined temperature, the inhaler device 100 permits inhalation by the user. After that, when the sensor 112 detects that the predetermined user input is performed, the inhaler device 100 may stop feeding electric power to the electromagnetic induction source 162.

In another example, in a period during which the sensor 112 detects that the user has inhaled, the inhaler device 100 may feed electric power to the electromagnetic induction source 162 to generate an aerosol.

FIG. 1 illustrates an example in which the susceptor 161 is included in the substrate 151 of the stick substrate 150; however, the inhaler device 100 is not limited to this example. For example, the holder 140 may have the function of the susceptor 161. In such a case, the inhaler device 100 generates eddy current in the holder 140 by a magnetic field generated by the electromagnetic induction source 162, so Joule heat is generated in the holder 140. Thus, the inhaler device 100 is capable of heating and atomizing the aerosol source included in the substrate 151 with Joule heat generated in the holder 140, so an aerosol can be generated from the stick substrate 150.

### 2. Configuration of Electromagnetic Induction Source

### 2.1. Basic Configuration

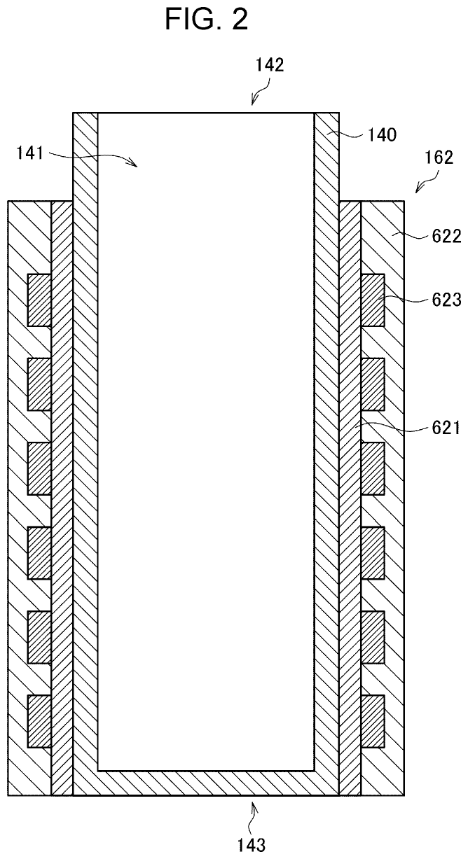

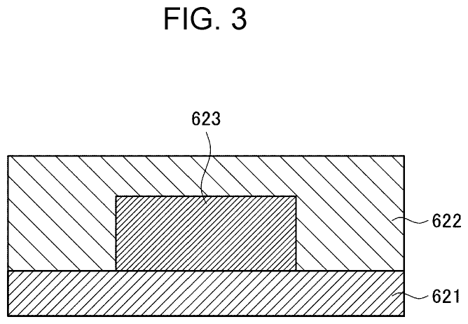

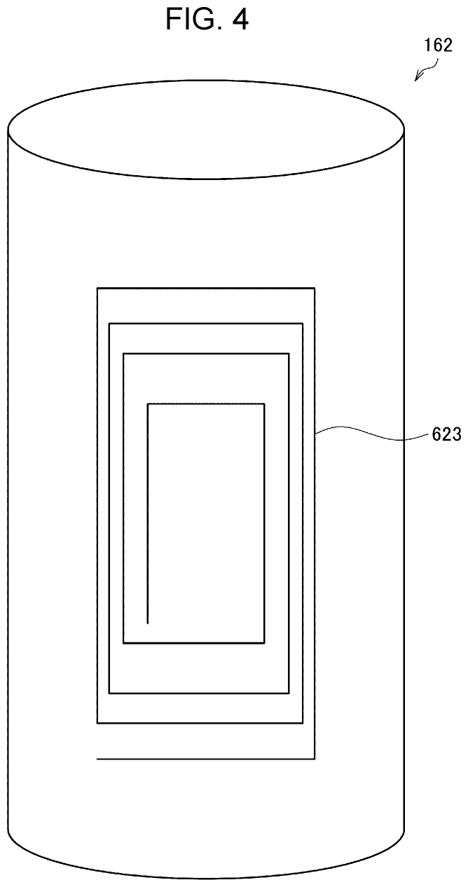

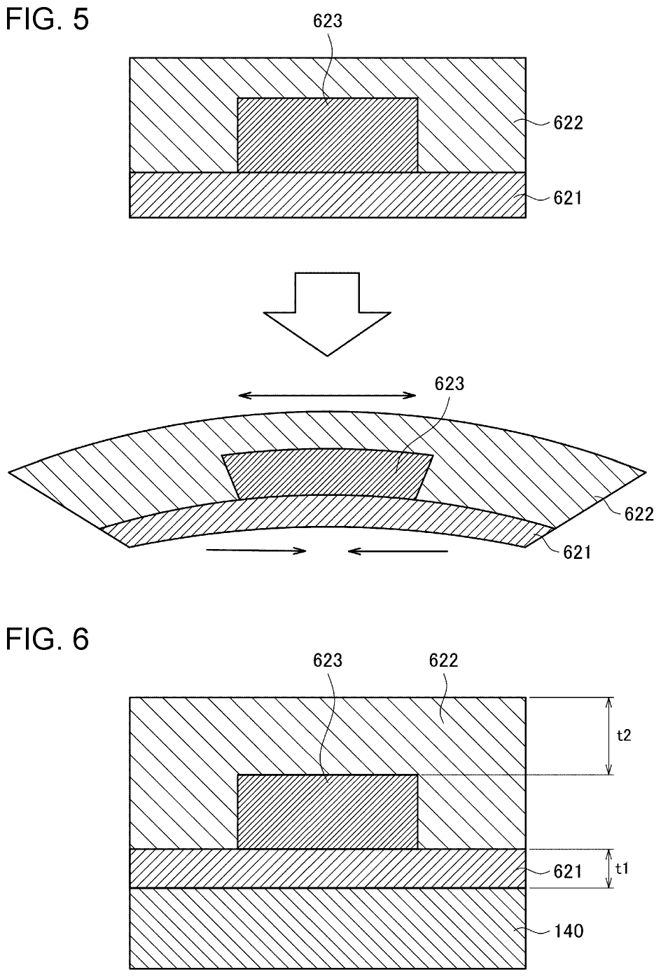

Next, the electromagnetic induction source 162 of the inhaler device 100 will be described with reference to FIGS. 2 to 5. FIG. 2 is a schematic sectional view of the holder 140 and the electromagnetic induction source 162. FIG. 3 is an enlarged sectional view that illustrates a region near a conductor layer 623 included in the electromagnetic induction source 162. FIG. 4 is a schematic diagram that illustrates an example of the shape of a coil made up of the conductor layer 623. FIG. 5 is a view that illustrates stress generated when the electromagnetic induction source 162 is deformed.

As shown in FIGS. 2 and 3, the electromagnetic induction source 162 has the opening 142 and the bottom 143 as ends and is provided along the side of the holder 140 that defines the columnar internal space 141. The electromagnetic induction source 162 is provided with a laminated structure of a first layer 621, the conductor layer 623, and a second layer 622 from the side of the holder 140.

However, as long as the electromagnetic induction source 162 is capable of inductively heating the susceptor 161, the electromagnetic induction source 162 does not need to be provided along the side of the holder 140. For example, the susceptor 161 in thermal proximity to the aerosol source can be provided at a location in the internal space 141 of the holder 140 or can be provided so as to define the internal space 141 of the holder 140. Therefore, in an example, the electromagnetic induction source 162 may be provided on the inner side of a housing (casing) of the inhaler device 100 at a location where the electromagnetic induction source 162 can inductively heat the internal space 141 of the holder 140. In another example, the electromagnetic induction source 162 may be provided on a support part (not shown) provided between the outer side of the holder 140 and the inner side of the housing (casing) of the inhaler device 100. The support part may be, for example, provided parallel to the outer side of the holder 140 and the inner side of the housing of the inhaler device 100, and the electromagnetic induction source 162 may be provided on the inner surface or outer surface of the support part.

The first layer 621 is made of an organic resin having electrical insulation properties and flexibility and formed in a film. The first layer 621 is wound in a cylindrical shape along the side of the holder 140. The first layer 621 may be made of, for example, a super engineering plastic, such as polyimide (PI) and polyetheretherketone (PEEK). Because the first layer 621 is in contact with the conductor layer 623 that produces heat when supplied with alternating current, the first layer 621 is made of a super engineering plastic having high heat resistance among organic resins.

The conductor layer 623 is made of a conductive material and is provided on the outer surface of the first layer 621. Specifically, the conductor layer 623 is a wiring layer that is supplied with alternating current and is traced on the outer surface of the first layer 621 so as to function as a coil. For example, the conductor layer 623 may be traced in a rectangular spiral shape on the side of the holder 140 as shown in FIG. 3 to form a transverse coil. Alternatively, the conductor layer 623 may be traced in a spiral shape so as to sterically wind around the side of the holder 140 to form a solenoid coil. The conductor layer 623 may be made of a metal material, such as silver, copper, gold, and aluminum. For example, the conductor layer 623 may be formed from silver nanoparticle ink with which it is easy to trace a selected pattern on a film substrate.

The second layer 622 is made of an organic resin having electrical insulation properties and flexibility and is provided on the outer surface of the first layer 621 so as to cover the conductor layer 623. The second layer 622 may be made of, for example, a super engineering plastic, such as polyimide (PI) and polyetheretherketone (PEEK). Because the second layer 622 is in contact with the conductor layer 623 that produces heat when supplied with alternating current, the first layer 621 is made of a super engineering plastic having high heat resistance among organic resins.

The first layer 621 and the second layer 622 may be made of the same organic resin or may be made of different organic resins. However, when the first layer 621 and the second layer 622 are made of the homogeneous or same organic resin, it is possible to further increase adhesion between the layers. When the first layer 621 and the second layer 622 are made of the homogeneous or same organic resin, the properties of each of the first layer 621 and the second layer 622 are, for example, allowed to be controlled with an additive, a filler, or the like to be mixed with a corresponding one of the first layer 621 and the second layer 622.

When the first layer 621 and the second layer 622 are made of the homogeneous or same organic resin, the first layer 621 and the second layer 622 mix with each other at the interface, with the result that the interface between the first layer 621 and the second layer 622 can be not clear. In such a case as well, it is understandable that the electromagnetic induction source 162 is made up of the first layer 621 and the second layer 622 from a difference in properties between the layers.

The electromagnetic induction source 162 having the above configuration is configured to sandwich the conductor layer 623 with the flexible first layer 621 and second layer 622. With this configuration, the first layer 621 and the second layer 622 can reduce a volume change in the conductor layer 623 due to heat production when supplied with alternating current, so it is possible to suppress occurrence of a crack or the like in the conductor layer 623.

As shown in FIG. 5, when the electromagnetic induction source 162 is wound around along the side of the holder 140, compressive stress occurs at the inner side (that is, the first layer 621 side) of the wound part, and tensile stress occurs at the outer side (that is, the second layer 622 side) of the wound part. In the conductor layer 623, the inner side of the wound part is covered with the first layer 621, and the outer side of the wound part is covered with the second layer 622. With this configuration, the electromagnetic induction source 162 can suppress a deformation due to compressive stress and tensile stress of the conductor layer 623, so it is possible to suppress peeling of the conductor layer 623 from the first layer 621, breakage of the conductor layer 623, or the like.

Particularly, in recent years, to further reduce the size of the inhaler device 100, the diameter of the internal space of the holder 140 is further reduced. For this reason, with the electromagnetic induction source 162 wound around the side of the holder 140 with a further reduced diameter (for example, a diameter of 7 mm), a radius of curvature of winding reduces, so compressive stress and tensile stress to be generated further increase. Since the above-described electromagnetic induction source 162 can suppress a deformation of the conductor layer 623 due to compressive stress and tensile stress, the electromagnetic induction source 162 can be suitably used for the inhaler device 100 reduced in size.

In the above description, the configuration in which the electromagnetic induction source 162 is wound around in a cylindrical shape along the side of the holder 140 such that the first layer 621 is opposed to the side of the holder 140 has been described. However, the technology according to the present invention is not limited to the above example. For example, the electromagnetic induction source 162 may be provided in a rectangular sheet shape and affixed to part of a region of the side of the holder 140 by adhesive or the like. When provided in a rectangular sheet shape, the electromagnetic induction source 162 may be affixed to the inner surface of the housing (casing) of the inhaler device 100 or may be affixed to the inner surface or outer surface of the support part provided between the holder 140 and the inhaler device 100.

### 2.2. Detailed Configuration

Next, a further detailed configuration of the electromagnetic induction source 162 will be described with reference to FIGS. 6 to 11. When the electromagnetic induction source 162 has a configuration that will be described in the following first to sixth specific examples, further preferred advantageous effects can be obtained.

### 2.2.1. First Specific Example

FIG. 6 is an enlarged sectional view that illustrates a region near the conductor layer 623 included in the electromagnetic induction source 162 according to the first specific example. As shown in FIG. 6, a film thickness t2 of the second layer 622 covering the conductor layer 623 may be greater than a film thickness t1 of the first layer 621.

Between compressive stress and tensile stress that are generated when the electromagnetic induction source 162 is wound around the side of the holder 140, the tensile stress is greater than the compressive stress. For this reason, in the conductor layer 623, breakage of the conductor layer 623 due to tensile stress is more likely to occur than peeling of the conductor layer 623 due to compressive stress. Therefore, in the first specific example, the film thickness t2 of the second layer 622 covering the conductor layer 623 is made greater than the film thickness t1 of the first layer 621, so it is possible to further strongly suppress a deformation due to tensile stress that occurs at the outer side (that is, the second layer 622 side) of the conductor layer 623. Thus, according to the first specific example, the electromagnetic induction source 162 is capable of further suppressing damage to the conductor layer 623, which occurs at the time when the electromagnetic induction source 162 is wound around the side of the holder 140.

### 2.2.2. Second Specific Example

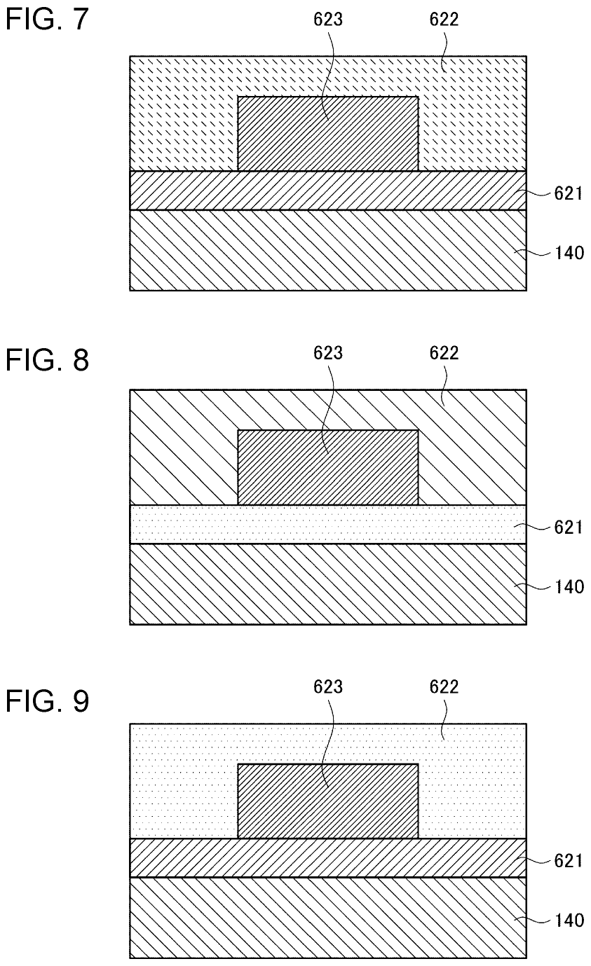

FIG. 7 is an enlarged sectional view that illustrates a region near the conductor layer 623 included in the electromagnetic induction source 162 according to the second specific example. As shown in FIG. 7, the first layer 621 and the second layer 622 may be provided as layers respectively having different properties from each other. For example, the Young's modulus of the second layer 622 may be lower than the Young's modulus of the first layer 621.

When the conductor layer 623 is covered with the second layer 622 that is lower in Young's modulus and more flexible than the first layer 621, it is possible to suppress occurrence of residual stress inside due to thermal expansion or thermal contraction. Therefore, according to the second specific example, the electromagnetic induction source 162 is capable of suppressing occurrence of breakage, crack, or the like in the conductor layer 623 due to residual stress caused by the thermal expansion or thermal contraction of the conductor layer 623.

The Young's modulus of each of the first layer 621 and the second layer 622 can be controlled by, for example, the type or polymerization degree of organic resin of a corresponding one of the first layer 621 and the second layer 622, or the type or amount of additive to be mixed. For example, the first layer 621 and the second layer 622 may be made of the homogeneous or same organic resin, and the Young's moduli may be controlled by changing the polymerization degree of the organic resin or the type or amount of additive to be mixed. In such a case, between the first layer 621 and the second layer 622, it is possible to increase adhesion between the layers while suppressing occurrence of residual stress in the conductor layer 623.

### 2.2.3. Third Specific Example

FIG. 8 is an enlarged sectional view that illustrates a region near the conductor layer 623 included in the electromagnetic induction source 162 according to the third specific example. As shown in FIG. 8, the first layer 621 and the second layer 622 may be provided as layers respectively having different properties from each other. For example, the heat conductivity of the first layer 621 may be higher than the heat conductivity of the second layer 622.

When the heat conductivity of the first layer 621 is higher than the heat conductivity of the second layer 622, heat generated in the conductor layer 623 as a result of being supplied with alternating current diffuses not at the second layer 622 side but mainly at the first layer 621 side. For this reason, the first layer 621 can increase the surface temperature of the holder 140 in the internal space 141 by heat diffused from the conductor layer 623 to the first layer 621 side. With this configuration, in the center-heating inhaler device 100 that inductively heats the stick substrate 150 from inside, the surface temperature of the holder 140 in the internal space 141 is further close to the temperature of the stick substrate 150 accommodated in the internal space 141. Therefore, according to the third specific example, the center-heating inhaler device 100 can reduce occurrence of condensation on the surface of the internal space 141.

The heat conductivity of each of the first layer 621 and the second layer 622 can be controlled by, for example, whether to mix a heat conductive filler to a corresponding one of the first layer 621 and the second layer 622 or the type or amount of a heat conductive filler to be mixed. For example, in the third specific example, it is applicable that no heat conductive filler is mixed to the second layer 622 and a heat conductive filler is mixed to the first layer 621. An inorganic insulating filler (for example, ceramics), such as alumina (Al₂O₃), magnesium oxide (MgO), boron nitride (BN), silica (SiO₂), and aluminum nitride (AlN), may be used as the heat conductive filler.

### 2.2.4. Fourth Specific Example

FIG. 9 is an enlarged sectional view that illustrates a region near the conductor layer 623 included in the electromagnetic induction source 162 according to the fourth specific example. As shown in FIG. 9, the first layer 621 and the second layer 622 may be provided as layers respectively having different properties from each other. For example, the heat conductivity of the second layer 622 may be higher than the heat conductivity of the first layer 621.

When the heat conductivity of the second layer 622 is higher than the heat conductivity of the first layer 621, heat generated in the conductor layer 623 as a result of being supplied with alternating current diffuses not at the first layer 621 side but mainly at the second layer 622 side. For this reason, the second layer 622 can release heat generated in the conductor layer 623 as a result of being supplied with alternating current, from the second layer 622 to outside the electromagnetic induction source 162. Therefore, according to the fourth specific example, the electromagnetic induction source 162 can suppress damage to the conductor layer 623 due to heat or an increase in the resistance value of the conductor layer 623.

The heat conductivity of each of the first layer 621 and the second layer 622 can be controlled by, for example, whether to mix a heat conductive filler to a corresponding one of the first layer 621 and the second layer 622 or the type or amount of a heat conductive filler to be mixed. For example, in the fourth specific example, it is applicable that no heat conductive filler is mixed to the first layer 621 and a heat conductive filler is mixed to the second layer 622. An inorganic insulating filler (for example, ceramics), such as alumina (Al₂O₃), magnesium oxide (MgO), boron nitride (BN), silica (SiO₂), and aluminum nitride (AlN), may be used as the heat conductive filler.

### 2.2.5. Fifth Specific Example

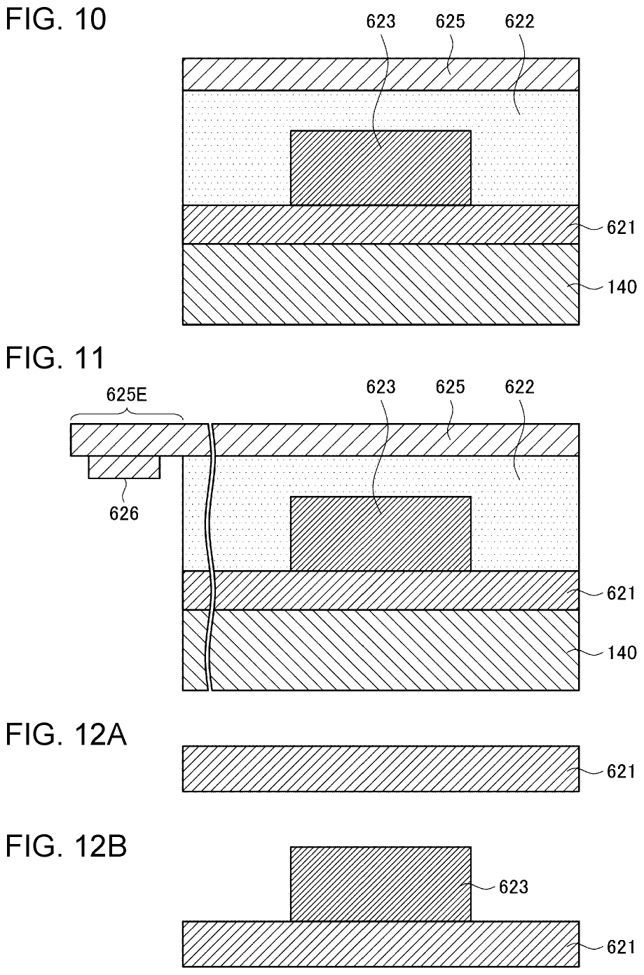

FIG. 10 is an enlarged sectional view that illustrates a region near the conductor layer 623 included in the electromagnetic induction source 162 according to the fifth specific example. As shown in FIG. 10, the electromagnetic induction source 162 according to the fifth specific example further includes a thermal diffusion layer 625 provided on the outer surface of the second layer 622 in addition to the configuration of the electromagnetic induction source 162 according to the fourth specific example.

The thermal diffusion layer 625 is thermally connected to the second layer 622 and can diffuse heat generated in the conductor layer 623 as a result of being supplied with alternating current, from the second layer 622 further to outside. Specifically, since the heat conductivity of the second layer 622 is higher than the heat conductivity of the first layer 621, heat generated in the conductor layer 623 as a result of being supplied with alternating current diffuses not at the first layer 621 side but mainly at the second layer 622 side. Heat diffused to the second layer 622 is further diffused to the thermal diffusion layer 625 provided on the outer surface of the second layer 622, so the heat is released to outside the electromagnetic induction source 162. With this configuration, the electromagnetic induction source 162 can further suppress damage to the conductor layer 623 due to heat or an increase in the resistance value of the conductor layer 623. The thermal diffusion layer 625 may be, for example, formed in a sheet shape from a metal material, such as copper and aluminum, having a high thermal conductivity. When the thermal diffusion layer 625 is made of a metal material, the thermal diffusion layer 625 can also function as a magnetic shield that shields against a varying magnetic field generated by the coil made up of the conductor layer 623. With this configuration, the electromagnetic induction source 162 can reduce the possibility that a magnetic field generated by the coil made up of the conductor layer 623 influences the other components such as the controller 116 of the inhaler device 100.

However, to further efficiently shield against a varying magnetic field generated in the coil made up of the conductor layer 623, a magnetic field convergence layer may be further provided between the thermal diffusion layer 625 and the second layer 622. The magnetic field convergence layer is made of, for example, a soft magnetic material having a high relative permeability, such as soft iron, silicon steel, and soft ferrite. The magnetic field convergence layer absorbs a magnetic flux generated in the coil made up of the conductor layer 623. Thus, the magnetic field convergence layer can shield so that the magnetic field generated in the conductor layer 623 does not leak to outside the electromagnetic induction source 162. With this configuration, the electromagnetic induction source 162 can further reduce the possibility that a magnetic field generated in the conductor layer 623 influences the other components such as the controller 116 of the inhaler device 100.

### 2.2.6. Sixth Specific Example

FIG. 11 is an enlarged sectional view that illustrates a region near the conductor layer 623 included in the electromagnetic induction source 162 according to the sixth specific example. As shown in FIG. 11, the electromagnetic induction source 162 according to the sixth specific example further includes a cooling portion 626 for cooling the thermal diffusion layer 625 in addition to the configuration of the electromagnetic induction source 162 according to the fifth specific example.

The cooling portion 626 is provided so as to be thermally connected to the thermal diffusion layer 625. The cooling portion 626 actively removes, from the electromagnetic induction source 162, heat generated in the conductor layer 623 as a result of being supplied with alternating current. The cooling portion 626 may be configured to include, for example, a Pertier element. Specifically, since the heat conductivity of the second layer 622 is higher than the heat conductivity of the first layer 621, heat generated in the conductor layer 623 as a result of being supplied with alternating current diffuses not at the first layer 621 side but mainly at the second layer 622 side. Heat diffused to the second layer 622 is further diffused to the thermal diffusion layer 625 provided on the outer surface of the second layer 622 and then cooled at the cooling portion 626. With this configuration, the electromagnetic induction source 162 can reduce a situation that heat diffused to the thermal diffusion layer 625 unintentionally heats the other components. The electromagnetic induction source 162 can further efficiently remove heat generated in the conductor layer 623.

The cooling portion 626 may be provided in, for example, an extended region 625E of the thermal diffusion layer 625. The extended region 625E is, for example, a region that, in the thermal diffusion layer 625 extending in the axial direction of the cylindrical shape of the first layer 621, is extended beyond the end of the first layer 621 to a side opposite to a side on which the opening 142 communicating with the internal space 141 of the holder 140 is provided. Alternatively, the cooling portion 626 may be provided on, for example, the inner surface (that is, the surface on which the second layer 622 is provided) of the thermal diffusion layer 625. When the cooling portion 626 is provided at such a location, the cooling portion 626 can be provided without increasing the size of the inhaler device 100.

However, the cooling portion 626 may be, of course, provided at a selected location thermally connected to the thermal diffusion layer 625.

### 2.3. Manufacturing Method

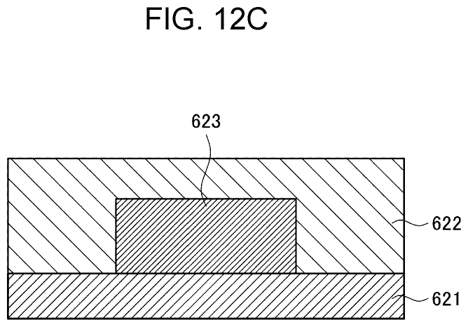

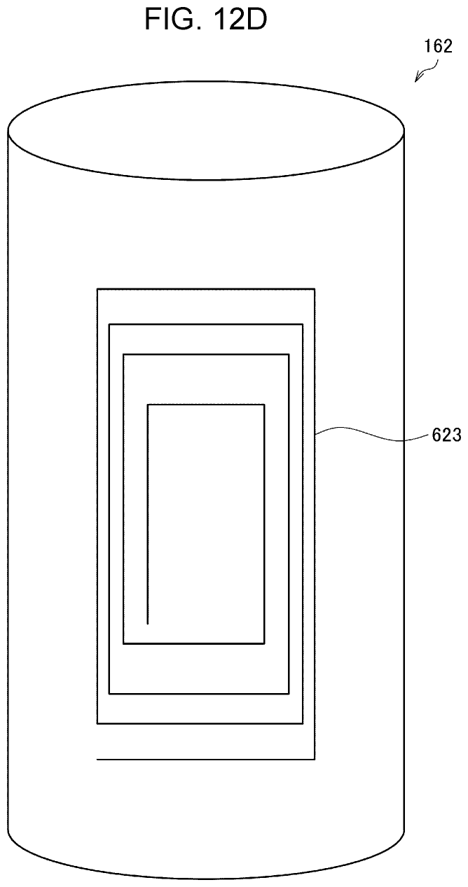

Furthermore, a manufacturing method for the electromagnetic induction source 162 will be described with reference to FIGS. 12A to 12D. FIGS. 12A to 12D are views that illustrate a process of manufacturing the electromagnetic induction source 162.

Initially, as shown in FIG. 12A, the film first layer 621 made of polyimide (PI) or polyetheretherketone (PEEK) is prepared.

Subsequently, as shown in FIG. 12B, the conductor layer 623 made of a metal material, such as silver, copper, gold, and aluminum, is formed on the first layer 621. The conductor layer 623 may be, for example, patterned in a rectangular spiral shape to form a transverse coil.

The conductor layer 623 may be formed by application and patterning through printing or may be formed by being deposited through vapor deposition and then patterned through photolithography and etching. For example, the conductor layer 623 may be formed by applying conductive ink (for example, silver nanoparticle ink) to be patterned on the first layer 621 through inkjet printing and curing the applied conductive ink by heating or ultraviolet light.

Subsequently, as shown in FIG. 12C, the second layer 622 is formed on the first layer 621 and the conductor layer 623. The second layer 622 may be formed by, for example, applying melt of an organic resin, such as polyimide (PI) and polyetheretherketone (PEEK), so as to cover the conductor layer 623 on the first layer 621 and then curing the melt.

After that, as shown in FIG. 12D, the electromagnetic induction source 162 is formed by winding a laminated body of the first layer 621, the conductor layer 623, and the second layer 622 into a cylindrical shape, with the result that the electromagnetic induction source 162 is formed. Specifically, the electromagnetic induction source 162 is formed by winding the laminated body of the first layer 621, the conductor layer 623, and the second layer 622 is wound around the side of the holder 140 such that the first layer 621 is opposed to the holder 140. At this time, the holder 140 and the first layer 621 may be bonded by interposing a heat-resistant bonding layer between the holder 140 and the first layer 621 or may be bonded by applying adhesive to the inner surface of the first layer 621.

The electromagnetic induction source 162 manufactured by the above process can suppress occurrence of a crack in the conductor layer 623 due to heat production and suppress brakeage or peeling of the conductor layer 623 when wound around in a cylindrical shape. Therefore, the electromagnetic induction source 162 can improve the reliability of the inhaler device 100.

The preferred embodiment of the present invention has been described in detail with reference to the attached drawings; however, the present invention is not limited to those examples. It is obvious that persons having ordinary skill in the art in the field of technology to which the present invention belongs can conceive of various modifications or alterations within the scope of the technical idea recited in the claims, and these can also be naturally interpreted as belonging to the technical scope of the present invention.

However, the present invention is not limited to the above-described embodiment. For example, the above-described electromagnetic induction source 162 causes the conductor layer 623 to function as an electrically-heated wire, so the electromagnetic induction source 162 can be used as a film heater. In such a case, the inhaler device 100 can heat the stick substrate 150 not by induction heating but by resistance heating. Therefore, the present invention may be applied to not only an induction heating inhaler device but also a resistance heating inhaler device, and can improve the reliability of the inhaler device by improving the reliability of the film heater.

The following configurations also belong to the technical scope of the present invention.

(1)
An aerosol generating system includes: a holder having an internal space in which a substrate containing an aerosol source is allowed to be accommodated; and
an electromagnetic induction source that generates a varying magnetic field in the internal space by using an alternating current to heat the aerosol source by induction heating caused by the varying magnetic field, wherein
the electromagnetic induction source includes
a first layer,
a conductor layer that is provided on one side of the first layer and that generates the varying magnetic field, and
a second layer provided on the one side of the first layer so as to cover the conductor layer.
(2)
In the aerosol generating system according to (1), the electromagnetic induction source is provided around the holder.
(3)
In the aerosol generating system according to (2), the electromagnetic induction source is wound around the holder in a cylindrical shape.
(4)
In the aerosol generating system according to (2) or (3), the electromagnetic induction source is provided around the holder such that the first layer is opposed to the holder.
(5)
In the aerosol generating system according to any one of (1) to (4), a Young's modulus of the second layer is lower than a Young's modulus of the first layer.
(6)
In the aerosol generating system according to any one of (1) to (5), a thickness of the second layer on the conductor layer is greater than a thickness of the first layer.
(7)
In the aerosol generating system according to any one of (1) to (6), an organic resin that is a component of the first layer is the same as an organic resin that is a component of the second layer.
(8)
In the aerosol generating system according to any one of (1) to (7), the substrate is heated from inside by the induction heating, and
a heat conductivity of the first layer is higher than a heat conductivity of the second layer.
(9)
In the aerosol generating system according to (8), the first layer contains an inorganic insulating filler.
(10)
In the aerosol generating system according to any one of (1) to (7), a heat conductivity of the second layer is higher than a heat conductivity of the first layer.
(11)
In the aerosol generating system according to (10), the second layer contains an inorganic insulating filler.
(12)
In the aerosol generating system according to (10) or (11), the electromagnetic induction source further includes a thermal diffusion layer provided on an outer surface of the second layer and thermally connected to the second layer.
(13)
In the aerosol generating system according to (12), the electromagnetic induction source is wound around the holder in a cylindrical shape such that the first layer is placed inside,
the thermal diffusion layer extends in an axial direction of the cylindrical shape beyond an end of the first layer, and
a cooling portion is provided in an extended region of the thermal diffusion layer and cools the thermal diffusion layer.
(14)
In the aerosol generating system according to (13), the cooling portion is provided in the extended region extending toward a side opposite to a side where an opening is provided in the axial direction of the cylindrical shape, and the opening communicates with the internal space of the holder.
(15)
In the aerosol generating system according to (13) or (14), the cooling portion is provided in the extended region on a surface opposed to the second layer.
(16)
In the aerosol generating system according to any one of (13) to (15), the cooling portion includes a Pertier element.
(17)
In the aerosol generating system according to any one of (12) to (16), the electromagnetic induction source further includes a magnetic field convergence layer provided between the second layer and the thermal diffusion layer and made of a magnetic substance.
(18)
In the aerosol generating system according to any one of (1) to (17), the conductor layer is a component of a coil of a transverse type or a solenoid type.
(19)
The aerosol generating system according to any one of (1) to (18) further includes the substrate accommodated in the internal space of the holder.
(20)
A manufacturing method for an aerosol generating system includes: preparing a film first layer; forming a conductor layer on the first layer for generating a varying magnetic field caused by an alternating current;
forming a second layer on the first layer such that the second layer covers the conductor layer; and providing a laminated body on a holder having an internal space in which a substrate containing an aerosol source is allowed to be accommodated, the laminated body including the first layer, the conductor layer, and the second layer.

### REFERENCE SIGNS LIST

100 inhaler device
111 power supply
112 sensor
113 notifier
114 memory
115 communicator
116 controller
140 holder
141 internal space
142 opening
143 bottom
150 stick substrate
151 substrate
152 inhalation port
161 susceptor
162 electromagnetic induction source
621 first layer
622 second layer
623 conductor layer
625 thermal diffusion layer
625E extended region
626 cooling portion

1. An aerosol generating system comprising:
a holder having an internal space in which a substrate containing an aerosol source is allowed to be accommodated; and
an electromagnetic induction source that generates a varying magnetic field in the internal space by using an alternating current to heat the aerosol source by induction heating caused by the varying magnetic field, wherein
the electromagnetic induction source includes
a first layer,
a conductor layer that is provided on one side of the first layer and that generates the varying magnetic field, and
a second layer provided on the one side of the first layer so as to cover the conductor layer, and
a heat conductivity of the second layer is higher than a heat conductivity of the first layer.

2. The aerosol generating system according to claim 1, wherein the first layer has a cylindrical shape.

3. The aerosol generating system according to claim 2, wherein the one side of the first layer is an outer side of the cylindrical shape.

4. The aerosol generating system according to claim 1, wherein the holder has a function of a susceptor which produces heat caused by the varying magnetic field.

5. The aerosol generating system according to claim 1, wherein further comprising:
a casing; and
a support part provided parallel to an outer side of the holder having a cylindrical shape and an inner side of the casing,
the electromagnetic induction source is provided on the support part.

6. The aerosol generating system according to claim 5, wherein the electromagnetic induction source is provided on an outer side of the support part.

7. The aerosol generating system according to claim 1, wherein the electromagnetic induction source is provided around the holder.

8. The aerosol generating system according to claim 7, wherein the electromagnetic induction source is wound around the holder in a cylindrical shape.

9. The aerosol generating system according to claim 7, wherein the electromagnetic induction source is provided around the holder such that the first layer is opposed to the holder.

10. The aerosol generating system according to claim 1, wherein a Young's modulus of the second layer is lower than a Young's modulus of the first layer.

11. The aerosol generating system according to claim 1, wherein a thickness of the second layer on the conductor layer is greater than a thickness of the first layer.

12. The aerosol generating system according to claim 1, wherein the first layer is composed polyetheretherketone (PEEK).

13. The aerosol generating system according to claim 1, wherein the second layer contains an inorganic insulating filler.

14. The aerosol generating system according to claim 1, wherein the electromagnetic induction source further includes a thermal diffusion layer provided on an outer surface of the second layer and thermally connected to the second layer.

15. The aerosol generating system according to claim 14, wherein
the electromagnetic induction source is wound around the holder in a cylindrical shape such that the first layer is placed inside,
the thermal diffusion layer extends in an axial direction of the cylindrical shape beyond an end of the first layer, and
a cooling portion is provided in an extended region of the thermal diffusion layer and cools the thermal diffusion layer.

16. The aerosol generating system according to claim 15, wherein the cooling portion is provided in the extended region extending toward a side opposite to a side where an opening is provided in the axial direction of the cylindrical shape, and the opening communicates with the internal space of the holder.

17. The aerosol generating system according to claim 15, wherein the cooling portion is provided in the extended region on a surface opposed to the second layer.

18. The aerosol generating system according to claim 15, wherein the cooling portion includes a Pertier element.

19. The aerosol generating system according to claim 1, wherein the conductor layer is a component of a coil of a transverse type or a solenoid type.

20. The aerosol generating system according to claim 1, further comprising the substrate accommodated in the internal space of the holder.
